(19) United States
(12) Patent Application Publication
(10) Pub. No.: US 2004/0195455 A1
(43) Pub. Date: Oct. 7, 2004

(54) Interactive kiosk for producing postcards from digital images stored on removable digital camera memory media

(75) Inventor: Michael Armand Maida, Fort Washington, PA (US)

Correspondence Address: CHARLES G. CALL, 68 HORSE POND ROAD, WEST YARMOUTH, MA, 02673-2516, US

(73) Assignee: Maida Automated Systems, Inc., Fort Washington, PA (US)

(21) Appl. No.: 10/390,283

(22) Filed: Mar. 17, 2003

(51) Int. Cl. B64C 1/00

(52) U.S. Cl. 244/129.1

(57) ABSTRACT

An interactive kiosk that permits the user to create custom postcards composed of photographs taken with the user's own digital camera. The postcards will be printed instantly by reading the memory (via camera's memory card or by wire transfer or infrared transfer of images) of the user's digital still or video camera. The kiosk contains a programmed computer that guides the user through the transfer and postcard creation process. The photograph/s will be printed in high quality color or black and white on one side with various options for borders and text messages. The back of the postcard will resemble a traditional postcard with space for a message to the recipient and the recipient's address.

### BACKGROUND AND SUMMARY OF THE INVENTION

The preferred embodiment of the present invention takes the form of an interactive kiosk that permits the user to create instant postcards composed of photographs taken with the user's digital camera. The user inserts the digital camera's removable memory card into a reader provided by the kiosk or utilizes infrared technology or other media to have the kiosk's computer read the digital camera's memory. The kiosk's computer displays all of the photographs on the card or in the digital camera's memory onto the computer's touch screen. The user then selects and formats one or more of the displayed photographs for printing onto one or more postcards. The kiosk visually and audibly guides the user through the data transfer and postcard creation process. The photographic images from the camera are printed in high quality color or black and white on one side of blank postcard stock, with optional additional printed borders, graphics or text messages selected by the user. The back of the postcard, preprinted or printed by the kiosk's duplex printer with or without postage, provides the conventional space the recipient's address and a written message.

The preferred kiosk employs a programmed computer, a touch screen display for displaying images and accepting input commands from the user, a memory card reader and/or a data port or infrared reader for accepting digitally recorded photographs from a digital camera, a supply tray for storing blank postcard stock, a mechanism for accepting payment in currency and/or by credit card, and a photographic quality printer for printing selected images on postcards delivered to the user. A communications interface such as a modem may be provided for communicating with one or remotely located computers which provide supporting services. The components of the kiosk are preferably housed within a suitable metal or plastic housing, or behind a secure panel, designed to attract tourists or other digital camera users.

These and other features of the invention will become more apparent through a consideration of the following detailed description. In the course of this description, frequent reference will be made to the attached drawings.

### BRIEF DESCRIPTION OF THE DRAWINGS

FIG. 1 is a perspective view of an interactive kiosk for producing postcards printed with photographic images from a digital camera;

FIG. 2 is a block diagram illustrating the interaction of the components used to implement the invention; and

FIG. 3 is a flowchart depicting the steps performed by a user to create postcards from the digital camera image data.

### DETAILED DESCRIPTION

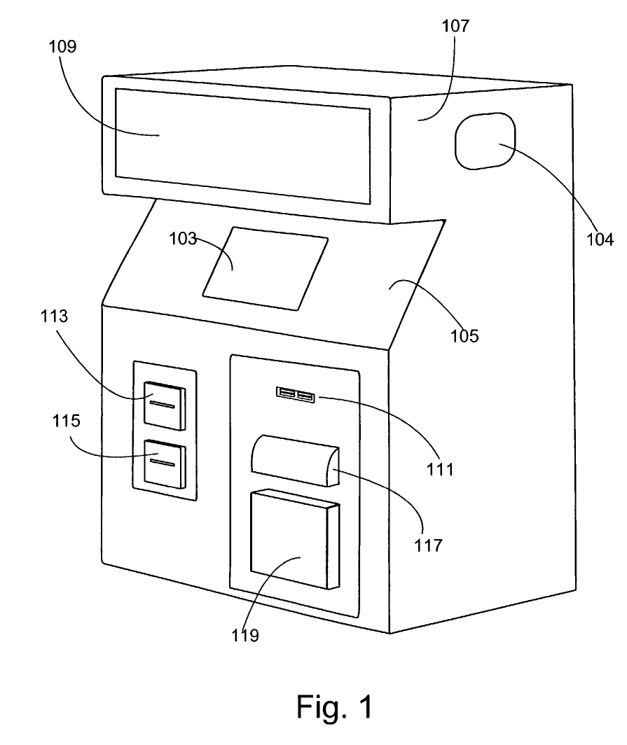

A kiosk embodying the invention as shown in FIG. 1 preferably includes a touch screen 103 for displaying information and prompting the user for information. An optional speaker located at 104 delivers audible spoken instructions and information to the user. The touch screen 103 is placed on an inclined panel 105 such that the touch screen 103 faces upwardly toward the user. An outwardly extending upper portion of the kiosk at 107 presents a front display area 109 that may be used to advertise the kiosk and attract the attention of passersby. The upper portion 107 overhangs the touch screen 103 to enhance its visibility in the presence of sunlight or bright overhead lighting.

A memory card reader at 111 accepts a variety of different kinds of removable data storage media commonly used by most digital cameras to hold image data.

Payment is made by the user using a bill acceptor seen at 113 and a credit card reader 115 positioned on the front of the kiosk.

The postcards which are printed with photographic images obtained via the memory card reader 111 are delivered to the user and exit downwardly through a hood 117 to an external bin 119.

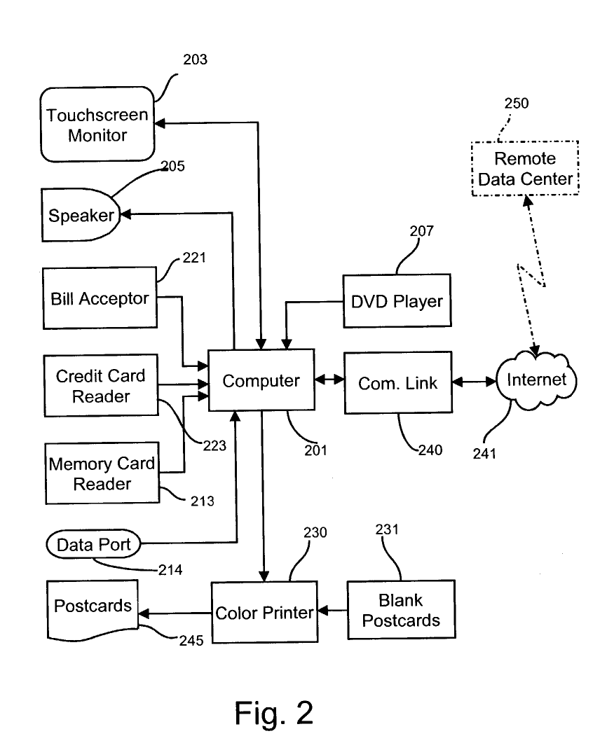

The kiosk houses the components illustrated in the block diagram of FIG. 2, including a programmed computer 201 which provides the primary control for the system. The computer 201 delivers visual information to the touch screen 203 and optionally audio to the speaker 205. The computer 201 and the touch screen 203 may take the form of a single integrated component, such as the model KS-300 produced by DFI Technologies, Inc., Sacremento, Calif. which includes a 15.1″ TFT LCD color screen which incorporates resistive, capacitive, or surface wave touch position sensing, supports an Intel Pentium III or Celeron processor up to 1.4 GHz, incorporates up to 512 MB SDRAM memory, and provides integrated output graphics, network communications, audio output, PC card slots, and PCI expansion slots.

An optional DVD player 207 which operates under the control of the computer 201 may be used to provide full motion video presentations to the touch screen 203 and speaker 205, or to an optional TV monitor (not shown). A standard DVD disk drive may be connected to the computer 201 and housed within the kiosk.

The user inserts a removable memory card from his or her digital camera into the memory card reader 213 which transfers image data to the computer 201 for display on the touch screen 203. The card reader 213 may be implemented with an Atech Pro III Flash Reader from Atech Flash Technology, Inc., Fremont, Calif. which may be coupled to the computer 201 via a USB port. The Atech Pro III reader provides four independent card slots to allow the user to insert four different kinds of media cards and supports all six popular flash media formats, including Compact Flash™ (Type I & II), IBM MicroDrive™, Smart Media™ (3.3V), MultiMedia™, Secure Digital™ and Memory Stick™ formats. The Pro III reader further provides an IEEE 1394 (FireWire) extension port on its front panel for easy connection to FireWire devices, such as digital cameras and camcorders.

After the user selects and formats a selected image for printing, the kiosk requests payment which may be made in cash using a bill acceptor 221 or by credit card using the credit card reader 223. The bill acceptor may be implemented with a Model LE39000 bill acceptor from Mars Electronics International which can be programmed to accept $1, $2, $5, $10, $20, $50 and $100 bills. The credit card reader may be implemented with a IntelliStripe 65™ Insertion Reader connected to the computer 201 via an RS-232 port to read magnetic stripe cards and/or communicate with ISO smart cards and many popular “memory” credit and debit cards.

When payment has been made, the image selected by the user is transmitted to a printer 230 which prints the image on one side of a blank postcard stock from a supply tray 231. The printer may be implemented by an OKI C7300 LED color printer available from Oki Data Americas, Inc., Mount Laurel, N.J. The OKI C7300 provides full color output seen at 245 at 20 pages per minute from single postcard size stock, or two postcards per sheet on 8 pt. Diamond Silk Cover Stock White paper (perforated to provide two 4″×6″ cards). The OKI C3700 provides input storage trays for storing up to 670 sheets of blank postcard stock.

A communications subsystem seen at 240, which may consist of a conventional modem connection to the Internet 241 via a dialup public telephone network to an Internet service provider (ISP), or an available network connection, may be used to connect the kiosk to a remote data center seen at 250. This communications link may be used for a variety of purposes, including updating the programs which execute on the computer 201 and control the kiosk, transmitting maintenance data such including information regarding the status of consumables (blank postcards, printer toner, etc.), verifying credit cards, and transmitting image data from cameras for storage on a central server on behalf of users.

Steps Performed by User

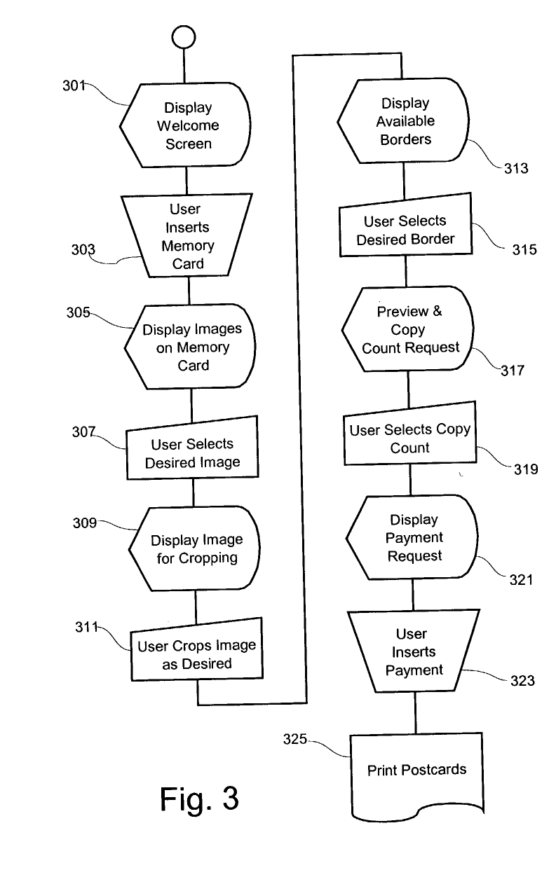

As indicated at 301 in FIG. 3, when the kiosk is not in use, it displays a welcome screen, or alternatively a promotional or instructional video generated by the DVD player depicted at 207 in FIG. 2.

As prompted by the touchscreen, user removes the memory card from his or her personal digital camera and inserts it into the card reader as indicated at 303.

The memory card reader reads the inserted memory card and displays the images stored on the touch screen (305). Using the touch screen, the user can scroll through the images that may be displayed in rows and columns.

The user selects one of the images or photographs following the prompts on the touch screen (307). The selected image is then displayed (309) and the user is given an opportunity to crop the image as desired using the touchscreen input (311).

After the image is cropped, it is displayed on the screen with one of a number of available stored borders and/or backgrounds (313), which the user may select (315). The price of the printed postcard(s) is then displayed along with a preview display showing one side or both sides of the postcard (317). The user may vary the quantity of printed cards desired (319), and may further select an optional electronic postcard that will be emailed to one or more user entered e-mail addresses supplied by the user. Suitable image management software for performing image cropping, editing, rotation and the like is available and includes the ImageLib Corporate Suite available from SkyLine Tools, Woodland Hills, Calif.

The kiosk then requests the user for payment (321) which can be submitted in cash or by credit card (323). Upon verification and acceptance of the payment, the kiosk will print the postcard(s) which are be dispensed into the output tray (325).

Afterwards, the kiosk will revert to the welcome screen at 301 upon which the user can remove their memory card or select photograph that will be used to create another postcard.

### CONCLUSION

It is to be understood that the preferred embodiment of the invention that has been described is merely one illustrative application of the principles of the invention. Numerous modifications and additions to the components and methods described above may be made without departing from the true spirit and scope of the invention.

What is claimed is:

1. An interactive kiosk for printing postcards with one or more images obtained from a digital camera comprising, in combination,
an input data receiver for obtaining image data from said digital camera,
a display screen for displaying said photographic images to a user,
selection means operable by said user for accepting a designation of one or more of said photographic images to be printed on one or more postcards,
a payment acceptor for receiving a designated monetary payment from said user,
a supply of blank postcards, and
a printer responsive to said payment input selection means and said payment acceptor for printing said one or more photographic images on one or more of said blank postcards and for delivering printed postcards to said user.

2. An interactive kiosk as set forth in claim 1 wherein said input data receiver includes a reader for accepting and reading a removable data storage device from said digital camera.

3. An interactive kiosk as set forth in claim 2 wherein said reader accepts a plurality of different kinds of removable data storage devices.

4. An interactive kiosk as set forth in claim 3 wherein said input data receiver further includes a data port for establishing a communications for receiving image data from a digital camera.

5. An interactive kiosk as set forth in claim 1 wherein said display means and said input selection means are both implemented with a touch screen.

6. An interactive kiosk as set forth in claim 2 wherein said display means and said input selection means are both implemented with a touch screen.

7. An interactive kiosk as set forth in claim 1 further including a speaker for providing spoken information and instructions to said user.

8. An interactive kiosk as set forth in claim 6 further including a speaker for providing spoken information and instructions to said user.

9. An interactive kiosk as set forth in claim 1 wherein said payment acceptor includes means for reading and accepting payment from a credit card submitted by said user.

10. An interactive kiosk as set forth in claim 1 wherein said payment acceptor includes a currency acceptor for receiving a cash payment from said user.

11. An interactive kiosk as set forth in claim 9 wherein said payment acceptor includes a currency acceptor for receiving a cash payment from said user.

12. An interactive kiosk as set forth in claim 1 further including a communications subsystem for permitting data to be exchanged between said kiosk and a remote data center.
